(19) United States
(12) Patent Application Publication
(10) Pub. No.: US 2021/0253254 A1
(43) Pub. Date: Aug. 19, 2021

(54) AIRLINE CATERING TROLLEY

(71) Applicant: THE BOEING COMPANY, Chicago, IL (US)

(72) Inventor: Gentry B. Stephens, Chesterfield, MO (US)

(21) Appl. No.: 16/790,921

(22) Filed: Feb. 14, 2020

(51) Int. Cl. B64D 11/00; B64D 11/04; B67D 1/08

(52) U.S. Cl. CPC B64D 11/0007; B67D 1/0888; B64D 11/04

(57) ABSTRACT

An airline catering trolley includes a mobile cart body, a beverage dispensing system disposed within the cart body, and a computing device mounted to the cart body and operatively connected to the beverage dispensing system. The beverage dispensing system includes a beverage dispenser extending from the cart body. The computing device includes a processor, a memory, an input/output device, and a transceiver, and is configured to receive a first input regarding a beverage to be dispensed through the input/output device, dispense a beverage from the beverage dispenser based on the first input, and communicate service data regarding operation of the airline catering trolley to an aircraft computing system of an aircraft.

### FIELD

This disclosure relates generally to airline catering trolleys and, more specifically, to beverage dispensing airline catering trolleys.

### BACKGROUND

Airline catering trolleys are used in aircraft to transport and serve soft drinks and other beverages during a flight and typically contain several drawers that store multiple cans of beverages per drawer. Each standard drawer can carry approximately 20 standard cans, which adds excess weight to the aircraft and requires multiple carts to manage the inventory for a flight.

To avoid carrying unnecessary beverages, many airlines attempt to optimize the drinks they carry by having employees manually count drink cans that go on and off after each flight to analyze usage and manage inventory, which can be a time consuming process. Airlines then use the information gathered to develop algorithms and ratios that allow them to optimize drink carried for particular flight times, days of week, destinations, etc. The empty cans after each flight must also be collected, disposed of, and counted to update the drink algorithms.

Cans that are not consumed during a flight also add unnecessary weight to aircraft that increases fuel consumption. For example, it has been estimated that one unused can of soda per year on every flight flown by one aircraft can increase the fuel cost up to $150.

### SUMMARY

In one embodiment of the present disclosure, an example airline catering trolley comprises a mobile cart body, a beverage dispensing system disposed within the cart body, and a first computing device mounted the cart body and operatively connected to the beverage dispensing system. The beverage dispensing system includes a beverage dispenser extending from the cart body. The first computing device includes a processor, a memory, an input/output device, and a transceiver, and is configured to receive a first input regarding a first beverage to be dispensed through the input/output device, dispense beverages from the beverage dispenser based on the first input, and communicate service data regarding operation of the airline catering trolley to an aircraft computing system of an aircraft.

In one embodiment, in the example airline catering trolley of the previous embodiment, the first computing device is removeably mounted to the cart body.

In one embodiment, in the example airline catering trolley of any of the previous embodiments, the first computing device is mountable to the aircraft.

In one embodiment, in the example airline catering trolley of any of the previous embodiments, the input/output device is a touchscreen.

In one embodiment, in the example airline catering trolley of any of the previous embodiments, the airline catering trolley comprises a second computing device mounted to the cart body and operatively connected to the beverage dispensing system. The second computing device includes a processor, a memory, an input/output device, and a transceiver, and is configured to receive a second input regarding a second beverage to be dispensed through the input/output device of the second computing device, dispense beverages from the beverage dispenser based on the second input, and communicate service data regarding operation of the airline catering trolley to the aircraft computing system of the aircraft.

In one embodiment, in the example airline catering trolley of any of the previous embodiments, the first computing device communicates with the aircraft computing system through a wireless connection.

In one embodiment, in the example airline catering trolley of any of the previous embodiments, the service data regarding operation of the airline catering trolley includes data analytics regarding beverages dispensed from the beverage dispensing system.

In one embodiment, in the example airline catering trolley of any of the previous embodiments, the service data regarding operation of the airline catering trolley includes information regarding service and maintenance of the airline catering trolley.

In one embodiment, in the example airline catering trolley of any of the previous embodiments, the beverage dispensing system comprises a water reservoir, a carbon dioxide reservoir, a sweetener reservoir, a plurality of compact flavor cartridges, a mixer, and a pump.

In another embodiment of the present disclosure, an example airline catering trolley comprises a mobile cart body, a beverage dispensing system disposed within the cart body, and a first computing device removeably mounted to the cart body and operatively connected to the beverage dispensing system. The beverage dispensing system includes a beverage dispenser extending from the cart body. The first computing device includes a processor, a memory, an input/output device, and a transceiver, and configured to receive a first input regarding a first beverage to be dispensed through the input/output device, and dispense beverages from the beverage dispenser based on the first input.

In one embodiment, in the example airline catering trolley of the previous embodiment, the first computing device is mountable to the aircraft.

In one embodiment, in the example airline catering trolley of any of the previous embodiments, the input/output device is a touchscreen.

In one embodiment, in the example airline catering trolley of any of the previous embodiments, the airline catering trolley comprises a second computing device mounted to the cart body and operatively connected to the beverage dispensing system. The second computing device includes a processor, a memory, an input/output device, and a transceiver, and is configured to receive a second input regarding a second beverage to be dispensed through the input/output device of the second computing device, and dispense beverages from the beverage dispenser based on the second input.

In one embodiment, in the example airline catering trolley of any of the previous embodiments, the first computing device in configured to collect data analytics regarding beverages dispensed from the beverage dispensing system.

In one embodiment, in the example airline catering trolley of any of the previous embodiments, the beverage dispensing system comprises a water reservoir, a carbon dioxide reservoir, a sweetener reservoir, a plurality of compact flavor cartridges, a mixer, and a pump.

In yet another embodiment of the present disclosure, an example airline catering trolley comprises a mobile cart body, a first means for receiving a beverage selection, and a means for dispensing a beverage based on the beverage selection. The first means for receiving a beverage selection is mounted to the cart body and is configured to communicate service data regarding operation of the airline catering trolley to an aircraft computing system of an aircraft. The means for dispensing is disposed within the cart body, is operatively connected to the first means for receiving the beverage selection, and includes a beverage dispenser extending from the cart body.

In one embodiment, in the example airline catering trolley of the previous embodiment, the first means for receiving a beverage selection comprises a touchscreen.

In one embodiment, in the example airline catering trolley of any of the previous embodiments, the touchscreen is removeably mounted to the cart body.

In one embodiment, in the example airline catering trolley of any of the previous embodiments, the airline catering trolley comprises a second means for receiving a beverage selection. The second means for receiving a beverage selection is mounted to the cart body and is configured to communicate service data regarding operation of the airline catering trolley to the aircraft computing system of the aircraft.

In one embodiment, in the example airline catering trolley of any of the previous embodiments, the service data regarding operation of the airline catering trolley includes at least one of data analytics regarding beverages dispensed from the beverage dispensing system and information regarding service and maintenance of the airline catering trolley.

The features, functions, and advantages that have been discussed can be achieved independently in various embodiments or may be combined in yet other embodiments further details of which can be seen with reference to the following description and drawings.

### BRIEF DESCRIPTION OF DRAWINGS

FIG. 1 is a front perspective view of an example airline catering trolley;

FIG. 2 is a front view of the airline catering trolley of FIG. 1;

FIG. 3 is a side view of the airline catering trolley of FIG. 1 showing an example schematic layout of an example beverage dispensing system; and

FIG. 4 is an example schematic illustration of one of the computing devices of the airline catering trolley of FIG. 1.

### DESCRIPTION

The example airline catering trolley disclosed herein includes a beverage dispensing system with flavor cartridges for the desired beverages, which eliminates the needs to carry cans on aircraft and saves weight on each flight. Drinks are dispensed using stackable plastic cups, which eliminates aluminum can waste, allows for a more efficient cleanup, and improves the customer experience by offering a larger selection of drink flavors. The example trolley optimizes space on an aircraft for beverages, optimizes the weight of beverages being served, reduces unused beverages, automates data gathering of beverages dispensed, and optimizes flight attendant workload and time by reducing the time looking for specific beverages, serving beverages, collecting and disposing of trash and recyclables, and analyzing beverages not consumed on a flight. The trolley can dispense many different types of beverages by micro-dosing blends of one or more concentrated ingredients with water, sweetener, and other beverage components at the point where the beverage is dispensed. The flavor cartridges store concentrated ingredients and can have radio frequency identification chips to detect supplies and to identify when resupplying needs to occur.

The example airline catering trolley also includes a computing device, such as an iPad or other touchscreen computing device, that is used to input beverage selections, control the beverage dispensing system to mix the concentrated flavors and other beverage components to dispense the beverage requested, and manage the inventory of the flavor cartridges and other beverage components. Since the computing device can keep track of beverages dispensed and the amount of the flavor cartridges and other beverage components used, the need to count and restock beverage cans and collect and dispose of empty cans, which saves time during and after each flight. In addition, the computing device can automatically transmit beverage use information, beverage component inventory information, and airline catering trolley and/or beverage dispensing system maintenance information to the aircraft computing system for use in determining restocking and maintenance requirements and allowing airlines to track and make adjustments to the inventory based on the information, again saving additional time.

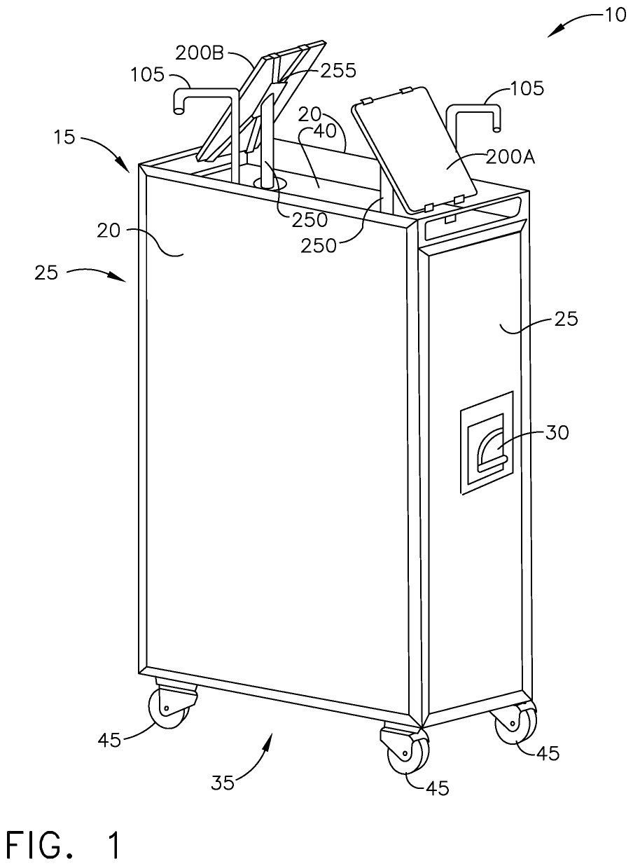

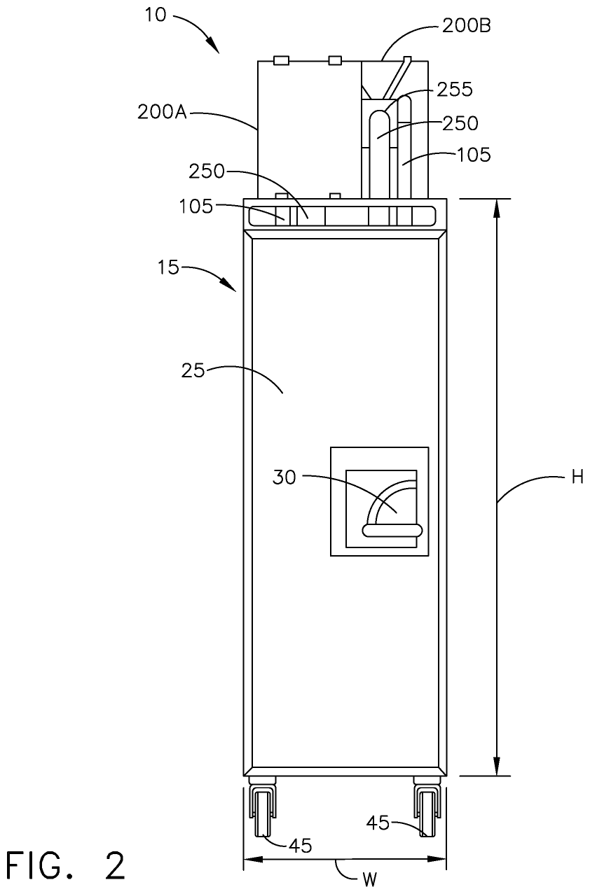

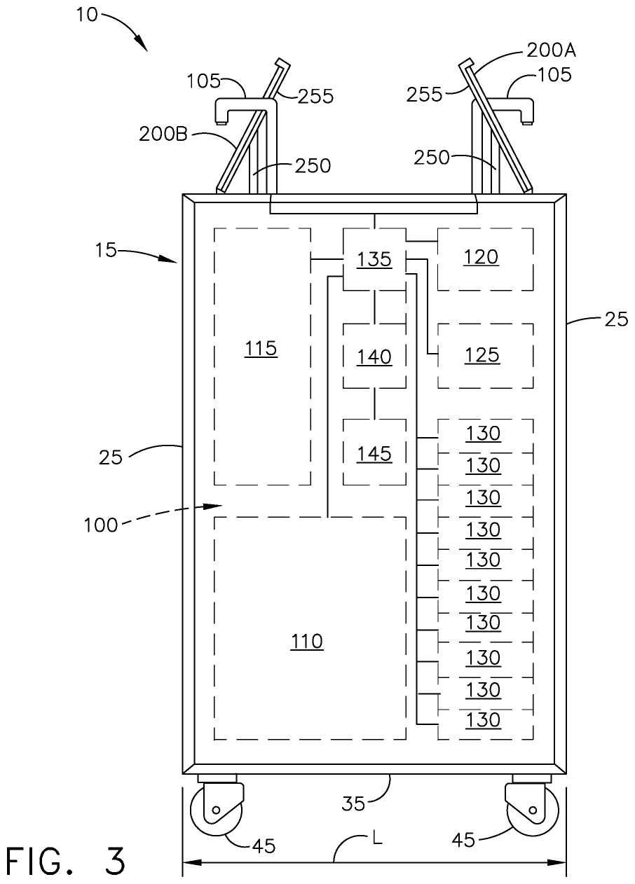

Referring to FIGS. 1-3, an example airline catering trolley 10 is shown that generally includes a mobile cart body 15, a beverage dispensing system 100, and first and second computing devices 200A, 200B.

In the example shown, mobile cart body 15 is a generally rigid box having a pair of opposing side walls 20 and a pair of opposing doors 225, which each have a handle/latch mechanism 30 to allow the door 225 to be opened, closed, and secured to allow access to the inside of mobile cart body 15. Alternatively, rather than the configuration shown, side walls 20 could be doors instead of solid walls, doors 225 could be solid walls, or all four sides of mobile cart body 15 could be configured as doors, depending on the desired configuration. A bottom wall 35 and opposing top wall 40 each extend between the pair of opposing side walls 20 and the pair of opposing doors 25. As shown, mobile cart body 15 can have a width W of approximately 0.3 meters (11¾ inches), a height H of approximately 1 meter (3 feet 3⅜ inches), and a length L of 0.75 meters (2 feet 5½ inches). A set of casters 45 is attached to bottom wall 35 to allow mobile cart body 15 to be easily moved and maneuvered within the aircraft.

Beverage dispensing system 100 is generally disposed within mobile cart body 15 and dispenses beverages based on inputs received by first and second computing devices 200A, 200B. In the example shown, beverage dispensing system 100 is configured to dispense mainly soft drinks and includes a water reservoir 110, a carbon dioxide reservoir 115, at least one sweetener reservoir, which in the example shown includes non-nutritive sweetener reservoir 120 and high fructose corn syrup reservoir 125, a plurality of compact flavor cartridges 130, a mixer 135, and a pump 140 within mobile cart body 15 and a beverage dispenser 105 that extends through and from top wall 40 of cart body 15 to dispense the requested beverages. Beverage dispensing system 100 could also include a rechargeable battery 145 to power pump 140 and possibly power or charge first and second computing devices 200A, 200B.

First and second computing devices 200A, 200B are mounted to cart body 15 and are operatively connected to beverage dispensing system 100, for example, through a wired connection or wireless connection, such as Bluetooth®, Wi-Fi, cellular, etc. Although shown with two computing devices, airline catering trolley could also have a single computing device, or more than two computing devices, depending on the configuration desired. In the example shown, first and second computing devices 200A, 200B are removably mounted to cart body 15 through posts 250 secured to top wall 40 of cart body 15 and brackets/cradles 255 that are mounted to posts 250 and retain first and second computing devices 200A, 200B. First and second computing devices 200A, 200B can also be configured to be plugged into and/or mounted to the aircraft 300, for example to the bulkhead of aircraft 300, when removed from cart body 15. This allows first and second computing devices 200A, 200B to be assigned to and stay with an particular aircraft and to be used with multiple airline catering trolleys, which allows for the use of less expensive airline catering trolleys and saves space in the aircraft.

In the example shown, first and second computing devices 200A, 200B are identical, therefore, only first computing device 200A will be described in detail herein and it will be understood that second computing devices 200B is the same as first computing device 200A.

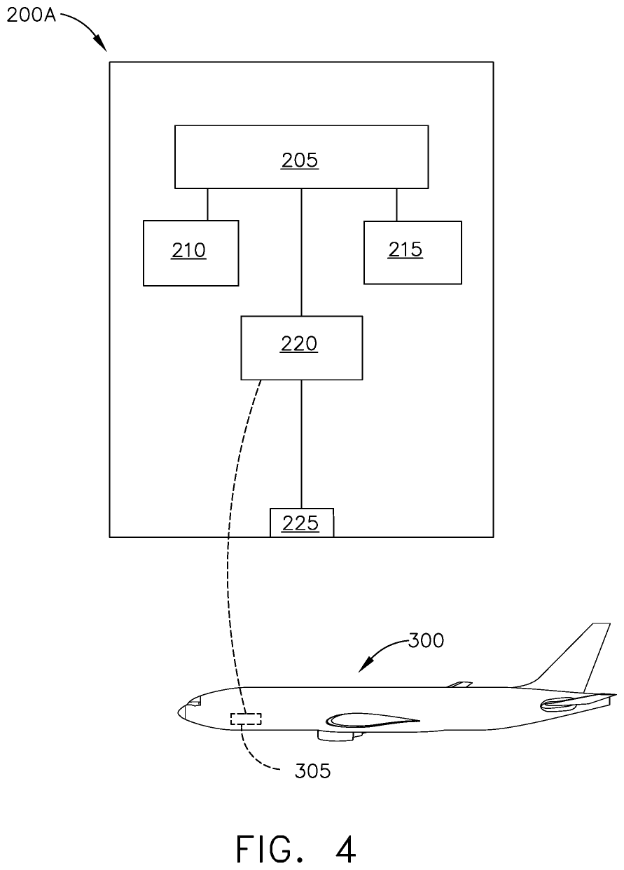

Referring to FIG. 4, first computing device 200A generally includes a processor 205, a memory 210 connected to processor 205, an input/output device 215 such as a touchscreen connected to processor 205, and a transceiver 220 connected to processor 205. Memory 210 of first computing device 200A includes computer readable instructions that, when executed by processor 205, configure first computing device 200A to receive a first input from a user regarding a first beverage to be dispensed (a beverage selection) through input/output device 215. Based on the beverage selection from the user, first computing device 200A then determine which beverage components are required for the selected beverage and communicates with beverage dispensing system 100 to dispense the selected beverage from beverage dispenser 105 based on the beverage selection.

As first computing device 200A receives beverage selections and dispenses beverages through beverage dispensing system 100, first computing device collects data analytics regarding the beverages requested and dispensed and monitors the levels of the beverage components in beverage dispensing system 100 of airline catering trolley 10. First computing device 200A can also be configured to communicate service data regarding operation of airline catering trolley 10, such as the data analytics collected regarding the beverages dispensed from beverage dispensing system 100, the levels of each of the beverage components, information regarding service and maintenance requirements of airline catering trolley 10, etc., to aircraft computing system 305 of aircraft 300 through transceiver 220. This communication with aircraft computing system 305 of aircraft 300 can be done through a wireless connection, such as a Bluetooth®, Wi-Fi, or cellular connection, or through a wired connection using an appropriate connector 225 such as a USB connector, micro USB connector, lightning connector, etc., and can be initiated manually by a user, can be scheduled to occur at predetermined times or intervals, or can be scheduled to occur at specific times, such as at the end of each flight. Communication of this information to aircraft computing system 305 allows aircraft computing system 305 to communicate with a ground crew system and provide information regarding what supplies and/or maintenance may be required before the aircraft lands and/or reaches its gate so the catering and maintenance ground crews can be ready to provide the supplies and/or maintenance required.

While various embodiments have been described above, this disclosure is not intended to be limited thereto. Variations can be made to the disclosed embodiments that are still within the scope of the appended claims.

What is claimed is:

1. An airline catering trolley, comprising:
a mobile cart body;
a beverage dispensing system disposed within the cart body and including a beverage dispenser extending from the cart body; and
a first computing device mounted to the cart body and operatively connected to the beverage dispensing system, the first computing device including a processor, a memory, an input/output device, and a transceiver, and configured to receive a first input regarding a first beverage to be dispensed through the input/output device, dispense beverages from the beverage dispenser based on the first input, and communicate service data regarding operation of the airline catering trolley to an aircraft computing system of an aircraft.

2. The airline catering trolley of claim 1, wherein the first computing device is removeably mounted to the cart body.

3. The airline catering trolley of claim 2, wherein the first computing device is mountable to the aircraft.

4. The airline catering trolley of claim 1, wherein the input/output device is a touchscreen.

5. The airline catering trolley of claim 1, comprising a second computing device mounted to the cart body and operatively connected to the beverage dispensing system, the second computing device including a processor, a memory, an input/output device, and a transceiver, and configured to receive a second input regarding a second beverage to be dispensed through the input/output device of the second computing device, dispense beverages from the beverage dispenser based on the second input, and communicate service data regarding operation of the airline catering trolley to the aircraft computing system of the aircraft.

6. The airline catering trolley of claim 1, wherein the first computing device communicates with the aircraft computing system through a wireless connection.

7. The airline catering trolley of claim 1, wherein the service data regarding operation of the airline catering trolley includes data analytics regarding beverages dispensed from the beverage dispensing system.

8. The airline catering trolley of claim 7, wherein the service data regarding operation of the airline catering trolley includes information regarding service and maintenance of the airline catering trolley.

9. The airline catering trolley of claim 1, wherein the beverage dispensing system comprises a water reservoir, a carbon dioxide reservoir, a sweetener reservoir, a plurality of compact flavor cartridges, a mixer, and a pump.

10. An airline catering trolley, comprising:
a mobile cart body;
a beverage dispensing system disposed within the cart body and including a beverage dispenser extending from the cart body; and
a first computing device removeably mounted to the cart body and operatively connected to the beverage dispensing system, the first computing device including a processor, a memory, an input/output device, and a transceiver, and configured to receive a first input regarding a first beverage to be dispensed through the input/output device, and dispense beverages from the beverage dispenser based on the first input.

11. The airline catering trolley of claim 10, wherein the first computing device is mountable to an aircraft.

12. The airline catering trolley of claim 10, wherein the input/output device is a touchscreen.

13. The airline catering trolley of claim 10, comprising a second computing device mounted to the cart body and operatively connected to the beverage dispensing system, the second computing device including a processor, a memory, an input/output device, and a transceiver, and configured to receive a second input regarding a second beverage to be dispensed through the input/output device of the second computing device, and dispense beverages from the beverage dispenser based on the second input.

14. The airline catering trolley of claim 10, wherein the first computing device in configured to collect data analytics regarding beverages dispensed from the beverage dispensing system.

15. The airline catering trolley of claim 10, wherein the beverage dispensing system comprises a water reservoir, a carbon dioxide reservoir, a sweetener reservoir, a plurality of compact flavor cartridges, a mixer, and a pump.

16. An airline catering trolley, comprising:
a mobile cart body;
a first means for receiving a beverage selection, the first means for receiving a beverage selection being mounted to the cart body and configured to communicate service data regarding operation of the airline catering trolley to an aircraft computing system of an aircraft; and
a means for dispensing a beverage based on the beverage selection, the means for dispensing disposed within the cart body, operatively connected to the first means for receiving the beverage selection, and including a beverage dispenser extending from the cart body.

17. The airline catering trolley of claim 16, wherein the first means for receiving a beverage selection comprises a touchscreen.

18. The airline catering trolley of claim 17, wherein the touchscreen is removeably mounted to the cart body.

19. The airline catering trolley of claim 16, comprising a second means for receiving a beverage selection, the second means for receiving a beverage selection being mounted to the cart body and configured to communicate service data regarding operation of the airline catering trolley to the aircraft computing system of the aircraft.

20. The airline catering trolley of claim 16, wherein the service data regarding operation of the airline catering trolley includes at least one of data analytics regarding beverages dispensed from the means for dispensing a beverage and information regarding service and maintenance of the airline catering trolley.
